(19) United States
(12) Patent Application Publication
(10) Pub. No.: US 2024/0181471 A1
(43) Pub. Date: Jun. 6, 2024

(54) MULTI-CYCLONE SEDIMENT FILTER

(71) Applicant: WATERCO LIMITED, Rydalmere (AU)

(72) Inventor: Pradeep TANDON, Rydalmere (AU)

(21) Appl. No.: 18/287,449

(22) PCT Filed: Apr. 7, 2022
(86) PCT No.: PCT/AU2022/050307

§ 371 Date: Oct. 18, 2023

(30) Foreign Application Priority Data
Apr. 20, 2021 (AU) 2021901156

(51) Int. Cl. B04C 5/28; B04C 5/081; B04C 5/12; B04C 5/14; E04H 4/12

(52) U.S. Cl. CPC B04C 5/28; B04C 5/081; B04C 5/12; B04C 5/14; E04H 4/1209

(57) ABSTRACT

A multi-cyclone sediment filter (100) includes a housing (260) disposed above and sealingly connected to a sediment bowl (110). A cyclone cartridge (370) is disposed in the cyclone housing (260), and has a plurality of conically shaped fluid cyclones (380), each having a small opening at a lower end and larger opening at an upper end, a fluid inlet into said cyclone housing (370) and for passage through said cyclone cartridge (370). A diffuser plate (510) sealingly connected to said cyclone cartridge (370) and housing (260), said diffuser plate (510) including diffuser tubes (520) extending downwardly into an upper open portion of one of said fluid cyclones (380), and a central upwardly extending diverter cone for directing fluid up and away from said diffuser plate (510). The sediment bowl (110) includes a sump (120) which is inclined relative to a plane perpendicular to a longitudinal axis of the multi-cyclone sediment filter (100), and a discharge port (180) is located at or near a lowermost region of said sump.

### TECHNICAL FIELD

The present invention relates to cyclonic separators, more particularly to a multi cyclone separator and sediment filter for fluids, utilising a plurality of cyclone apparatus arranged in a radial pattern to remove particulate debris from the fluid.

### BACKGROUND OF THE INVENTION

Cyclonic separators are used for separating unwanted debris from fluids by using centrifugal force. The fluid is typically injected obliquely into the cyclonic separator elements such that a circular flow is set up. The centrifugal forces act on the debris, which is more dense than the fluid in which it is suspended, forcing the denser material outwardly and toward the perimeter of the separation chamber. The conical shape of the separator elements does not allow the denser material to exit the top of the inverted cone. Instead, the substantially debris-free fluid surrounding the center of the vortex is extracted and re-circulated, while the debris is collected and discarded.

Some cyclonic filters are used in a component system in combination with a separate filter housing and a separate sludge receiver housing. These component systems require regular cleaning and changing of several housings and filter bags. This increases apparatus down time and the amount of inventory needed to maintain the system in working order.

Cyclonic separation is commonly used in vacuum cleaners to remove fine and large debris from an air stream created by the vacuum. Air is injected tangentially into the cyclonic chamber and the resultant vortex spins and forces debris to the walls of the cyclonic chamber, while clean air exits the top of the vortex.

Other background systems of interest are documented in several patents, including U.S. Pat. No. 4,726,902 to Hubbard, which teaches a cyclone degritter that receives water inflow and directs the water through cyclone units with an underflow directed to a grit pot and an overflow of substantially purified water.

U.S. Pat. No. 7,306,730 Tashiro et al, describes a cyclone-type separator for separating solid particles from liquid. The apparatus comprises a hollow cylindrical body with inlet and discharge ports. The main body causes liquid to swirl or eddy in the main body, and the foreign matter contained in the liquid is separated by centrifugal force as the liquid swirls. The foreign matter falls along an inner surface of the main body and is discharged through the discharge port. Clean liquid is discharged from the discharge port. Tashiro et al show the introduction of fluid into the side of a single cyclone.

U.S. Pat. No. 4,793,925 to Duval et shows a single element separator which includes a body with an inlet and outlet that induces a vortex in fluid by driving it into an inverted conical chamber. Solid particulate materials fall out of a port in the bottom of the cone.

U.S. Pat. Appl. Ser. No. 2006/0283788 by Schreppel, Jr., teaches a three stage separator in which swirl chambers and aeration produces bubble formation and collapse that creates localized high pressure. In a first stage the liquid passes through a swirl chamber and rotating flow is dispersed to oxide and mix it. The swirl chamber includes a spiral passageway for the centrifugal flow of the influent material to be dispersed outwardly from the chamber. The swirl chamber typically includes a top cover and a bottom cover substantially closing the cylinder except for a central opening in the top cover for release of lighter materials and a central opening in the bottom cover for the heavy contaminants.

U.S. Pat. No. 5,879,545, to Antoun, describes a compact cyclonic filter assembly used for separating unwanted debris from a fluid. The cyclonic filter assembly uses the centrifugal forces to separate large pieces of debris from the fluid and a filter to separate the remaining unwanted debris from the fluid. The invention can be contained in a compact single housing which may be disassembled for easy cleaning and replacement of parts. The cyclonic filter assembly has a vertically oriented cylindrical tube which receives a tangential injection of the debris laden fluid. The tangential injection causes the fluid to circulate around a cylindrical vortex finder which is inside of and coaxial with the tube. The centrifugal forces acting on the debris causes the debris to move outward away from the center of the vortex. The vortex finder has an opening which pulls in the relatively clean fluid near the center of the vortex while the debris laden fluid settles into a collection chamber below the cylindrical tube. The invention has a filtration chamber housing a filter element which is used to extract the remaining unwanted debris from the fluid before it exits the cyclonic filter assembly.

U.S. Pat. No. 6,485,536 to Masters describes a particle separator which separates entrained particulates from a fluid. The particle separator utilizes an auger enclosed within a cylinder to form a cyclonic chamber, through which air is propelled. The centrifugal motion of particles within the air causes the particles to exit the cyclonic chamber through ducts, and the particles are separated in collection chambers.

The applicant's own earlier invention is disclosed in PCT patent application PCT/IB2008/001633 (WO2008/155649) entitled Multi-cyclone sediment filter. That invention has proven to operate well, and has been commercially successful. However, a drawback of that Multi-cyclone sediment filter concerns the degree of efficiency with regard to the percentage of debris collected during each pass through the filter. A considerable amount of debris is not removed during each pass through the filter, and hence returned to the body of water.

The applicant has noted that small improvements in efficiency of debris collection can lead to considerable improvements in filtration performance, and hence swimming pool water quality.

### OBJECT OF THE INVENTION

It is an object of the present invention to substantially overcome or at least ameliorate one or more of the above disadvantages, or at least to provide a useful alternative.

### SUMMARY OF THE INVENTION

In a first aspect, the present invention provides a multi-cyclone sediment filter comprising:
a sediment bowl for collecting sediment;
a cyclone housing disposed above and sealingly connected to said sediment bowl;
a cyclone cartridge disposed in said cyclone housing, said cyclone cartridge including:
   a plurality of conically shaped fluid cyclones, each having a small opening at a lower end and larger opening at an upper end,
   a fluid inlet for introducing fluid into said cyclone housing and for passage through said cyclone cartridge;
a diffuser plate sealingly connected to said cyclone cartridge and said cyclone housing, said diffuser plate including a plurality of diffuser tubes, each diffuser tube extending downwardly into an upper open portion of one of said fluid cyclones, and a central upwardly extending diverter cone for directing fluid over said diverter cone up and away from said diffuser plate;
wherein the sediment bowl includes a sump which is angularly inclined relative to a plane which is perpendicular to a longitudinal axis of the multi-cyclone sediment filter, and a discharge port is located at or near a lowermost region of said sump.

### BRIEF DESCRIPTION OF THE DRAWINGS

A preferred embodiment of the invention will now be described by way of specific example with reference to the accompanying drawings, in which:

FIG. 1 is a side view of the assembled multi-cyclone sediment filter;

FIG. 2 is 1 is a perspective view of the assembled multi-cyclone sediment filter;

FIG. 3 is an exploded perspective view of the multi-cyclone sediment filter;

FIG. 4 depicts a cyclone body of the multi-cyclone sediment filter;

FIG. 5 depicts a separator of the multi-cyclone sediment filter;

FIG. 6 depicts a manifold plate of the multi-cyclone sediment filter;

FIG. 7 depicts a sediment bowl of the multi-cyclone sediment filter;

FIG. 8 is a cross-sectional side view of a cyclone cartridge of the multi-cyclone sediment filter;

FIG. 9 is a prior art cyclone cartridge;

FIG. 10 depicts an alternative dome shaped cap of the multi-cyclone sediment filter;

FIG. 11 depicts an alternative cyclone housing of the multi-cyclone sediment filter;

FIG. 12 depicts the cap of FIG. 11 and cyclone housing of FIG. 12 secured with a band and clamp; and

FIG. 13 depicts a high-pressure variant of the multi-cyclone sediment filter.

### DETAILED DESCRIPTION OF THE PREFERRED EMBODIMENTS

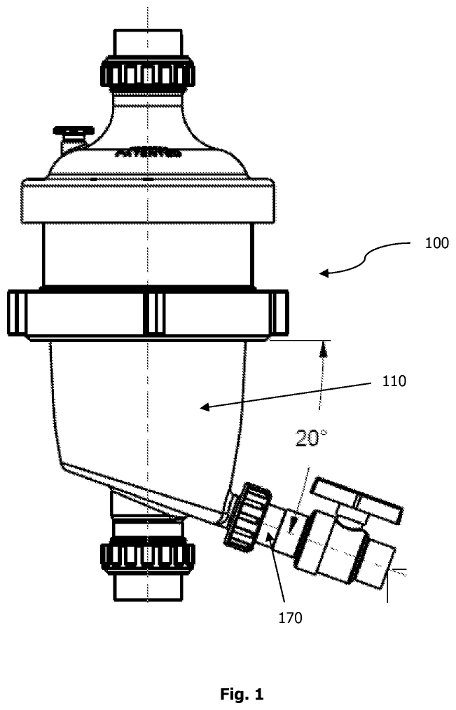

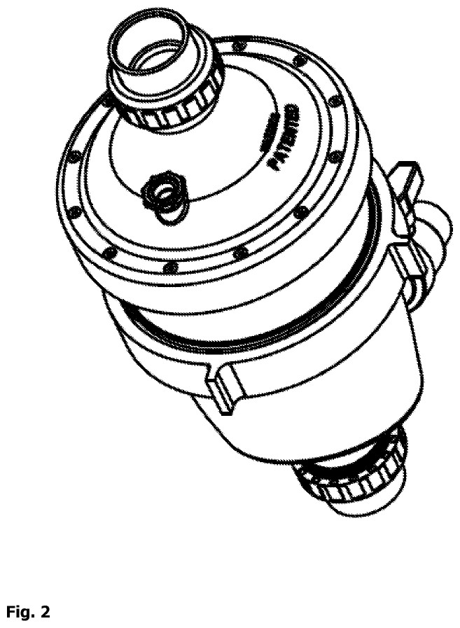

Referring to FIGS. 1 to 7, like reference numerals refer to like components in the various views. There is disclosed herein a new and improved multi-cyclone separator or sediment filter 100.

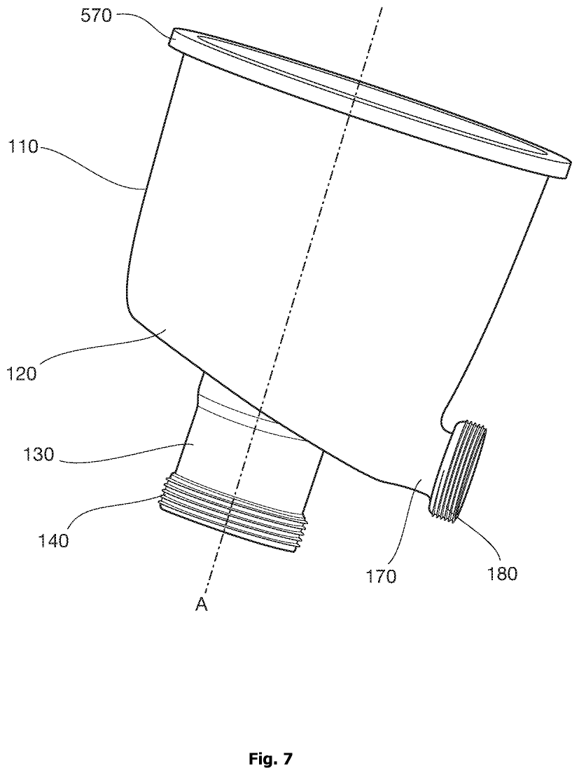

The multi-cyclone sediment filter 100 includes a lower sediment bowl 110 which is depicted in isolation in FIG. 7. The sediment bowl 110 has a sloping base portion, or sump, 120, with a fluid inlet 130, preferably a tube axially disposed on the central axis A through the bottom. The fluid inlet 130 includes a threaded male end 140 which is connected to a pressurized fluid source through a fluid source tube 150 via a locking collar 160 having female threads complementary to the male end of the fluid inlet tube 150.

Advantageously the sump 120 slopes toward the discharge port 180 which is located at a lowermost region of the sump 120 for improved efficiency in flushing collected sediment.

Extending radially outwardly and downwardly from the bottom portion of the sediment bowl 110 is a sediment bowl drain tube 170 having a threaded male end or discharge port 180 for connection to a drain outlet pipe 190 via a locking collar 200. The drain outlet pipe 190 preferably includes a purge valve 210 for selective draining of the sediment bowl 110.

Referring to FIG. 1, the sump 120 is angled at an angle between about 10 degrees and 30 degrees relative to horizontal, and most preferably about 20 degrees. The sediment bowl drain tube 170 is located at or near a low point of the sump 120, and also angled at the same, or a similar angle to the base of the sump 120.

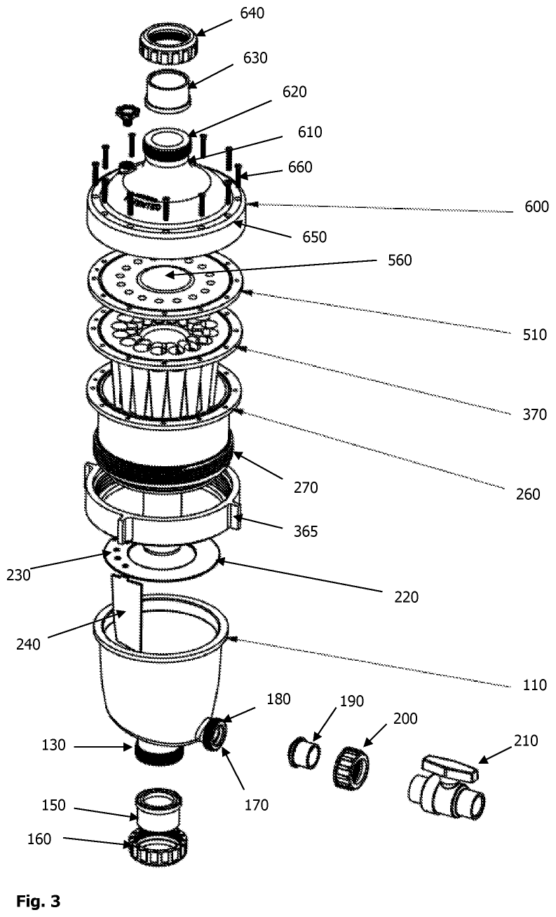

Referring to FIG. 3, a generally planar and annular particle bed 220 is positioned toward the bottom of the sediment bowl 110 and includes a plurality of holes 230 that allow the finest sediment to settle into the bottom of the sediment bowl while restricting passage of larger particulate material. The particle bed 220 is stabilized by one or more stand-offs 240 disposed on the underside of the particle bed 220. The particle bed 220 is configured to sit in a generally horizontal configuration, such that the particle bed 220 is located closest to the sump 120 at the side of the sediment bowl 110 which is diametrically opposite the sediment bowl drain tube 170.

The multi-cyclone sediment filter 100 includes a cylindrical cyclone housing 260 having male threads 270 at or near its exterior lower end.

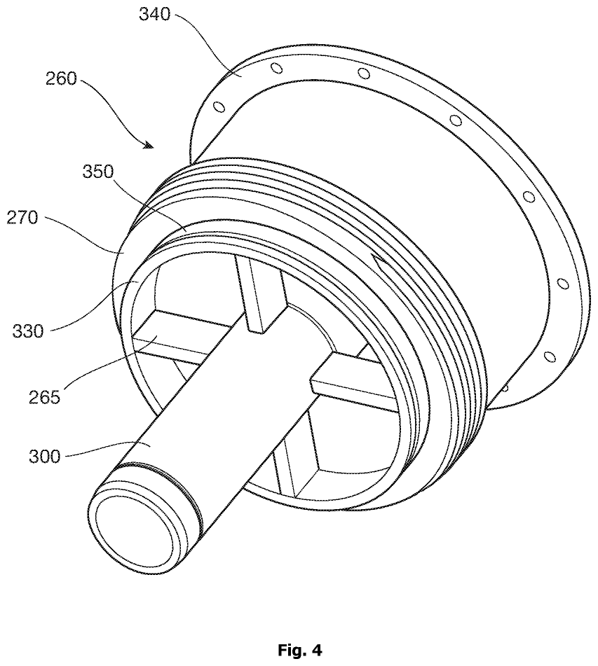

Referring to FIG. 4, the base of the cylindrical cyclone housing 260 is generally open, with the exception of a cross-shaped support 265 and an integrally formed fluid conduit 300 extending downwardly from the underside of the cylindrical cyclone housing 260. The cross-shaped support 265 provides a clear passage for sediment to drop down into the sediment bowl 110, and the cross-shaped support 265 supports the conduit 300 and provides additional structural rigidity.

A sealing ring 330 is located on the lower, underside of the cylindrical cyclone housing 260 and sized with an exterior circumferential diameter to fit tightly against the interior side of the upper portion of the sediment bowl 110, and a flange 340 extending outwardly from its upper edge. The sealing ring 330 includes an exterior annular groove 350 in which an O-ring seal is located.

The sediment bowl 110 and cyclone housing 260 are connected by inserting the sealing ring 330 into the upper portion of the sediment bowl 110 so that the outermost portion of the underside of the cyclone housing 260 is seated upon the flange or rim 250 of the sediment bowl 110. A threaded locking collar 365 is then screwed onto the exposed male threads of the cyclone housing. When this is done, the fluid conduit 300 is brought into fluid communication with, and into a tight sealed engagement with, the fluid inlet 130.

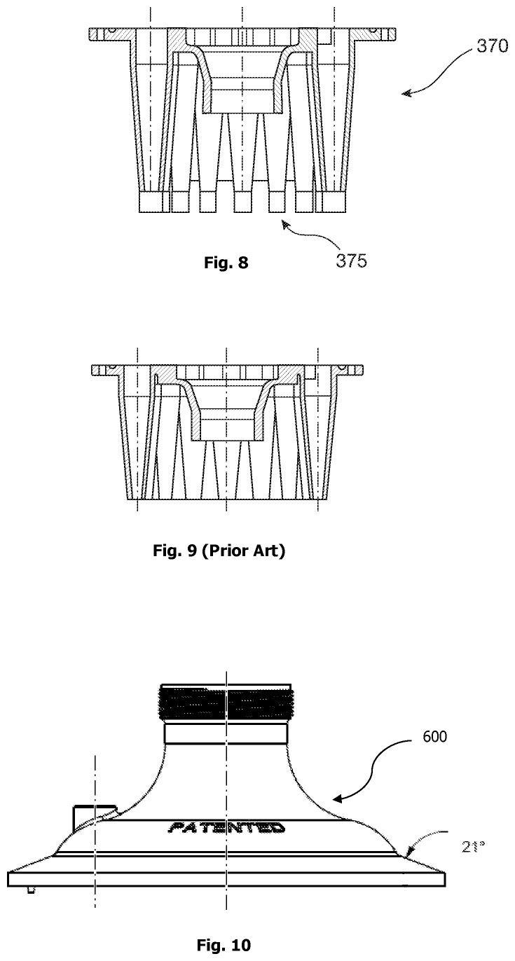

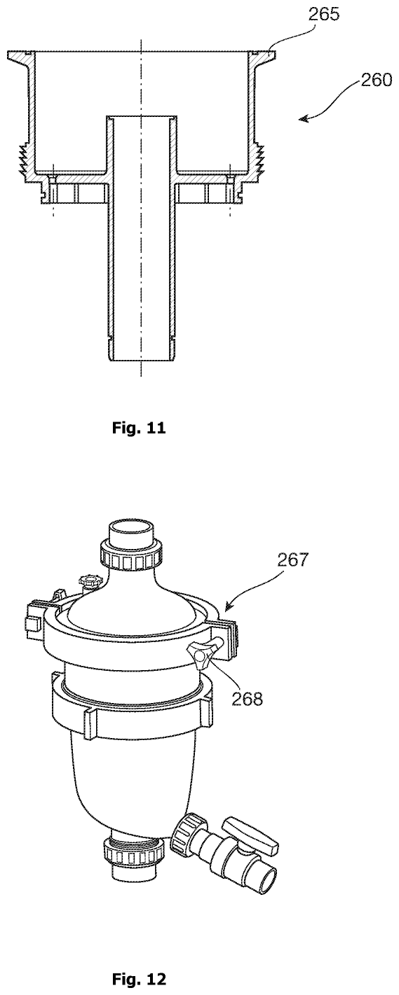

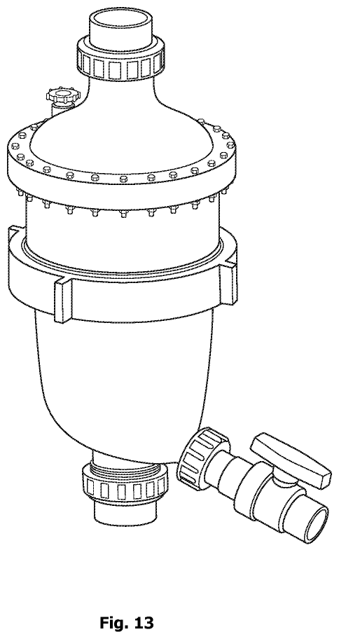

An alternative embodiment of the cyclone housing 260 is depicted in FIG. 11. The cyclone housing 260 of FIG. 11 is intended to be secured to the cap 600 of FIG. 10 with a band 267 and clamp 268 which enables quick disassembly, and obviates the need to use screws and bolts. The upper rim of the cyclone housing 260 includes a tapering flange 265 for engagement with the band 267. In a preferred embodiment, the rim flange 265 is tapered at an angle of about 21 degrees. By tightening the clamp 268, the bland 267 applies increased pressure on the flange 265.

FIG. 13 depicts a high-pressure version of the multi-cyclone sediment filter 100, intended to operate at internal pressures up to about 7 Bar. This embodiment includes additional bolts and nuts to secure the flanges of the cap 600 and the upper rim of the cyclone housing 260. There are preferably 24 bolts used in this high pressure variation.

Referring to FIG. 5, the multi-cyclone sediment filter 100 includes a cyclone cartridge or magazine 370, including a plurality of vertically disposed inverted conical fluid cyclones 380 having open upper and lower ends, the latter having the smaller openings, such that the cross-sectional area of the passage through each cyclone 380 decreases from top to bottom.

In one embodiment, there are 16 cyclones 380 whilst in another embodiment there are 12 cyclones 380. In each embodiment, the cyclones 380 are evenly spaced on a constant pitch circle diameter. It will be appreciated that the cyclone cartridges 370 are interchangeable, such that the use can switch between a 12 cyclone cartridge and a 16 cyclone cartridge and vice versa depending on conditions.

Referring to the cross-sectional view of FIG. 8, the cyclones 380 have been extended in length along a longitudinal axis when compared with the prior cyclones depicted in FIG. 9. In this way, the length of the tapering section of each cyclone has been increased from about 128.5 mm to about 135 mm-145 mm and most preferably around 138.9 mm. In addition, the internal diameter of the narrow end of each tapered cyclone 380 is reduced to about 8.5 mm to 9.5 mm and most preferably about 8.9 mm as opposed to about 10.6 mm in the prior art cartridge.

Furthermore, in the prior art cartridge, the cyclones are tapered along their entire length. In contrast, in the present disclosure, the narrow end of each cyclone 380 terminates with a short tubular outlet 375 which is about 15 mm in length. The outlet 375 is not tapering, and has a generally constant diameter along its length. These improvements over the prior art provide more resident time for the cyclonic action to trap more sediment.

Another change in the present disclosure concerns the location of the cyclones 380. In particular, the cyclones are located on a reduced pitch circle diameter when compared with the prior art cyclone cartridge of FIG. 9. The centres of the cyclones 380 are now on a pitch circle diameter of about 150 mm-160 mm and preferably about 154 mm, which is significantly reduced when compared with the prior art cartridge. This reduction in pitch circle diameter results in the cyclones 380 being located closer to the central longitudinal axis AA, resulting in the water entering the cyclones 380 with greater velocity, which assists to improve sediment entrapment.

The central portion of the cyclone cartridge 370 includes a cyclone cartridge inlet tube 390 brought into axial alignment with the fluid conduit 300 of the cyclone housing 260 in the assembled apparatus. The cyclone cartridge inlet tube 390 includes a flared upper end 405 that encourages water under pressure and high velocity to move to a plurality of vortex openings 410 and through vortex channels 420 which extend to circular vortex ports 430 in fluid communication with the open upper ends of the inverted conical fluid cyclones 380. An O-ring seal is disposed in an annular groove 450 in the upper end of the fluid conduit to complete the seal with the cyclone cartridge inlet tube.

The upper edge of the cyclone cartridge includes an outwardly extending flange 460 that is seated upon the flange 340 of the cyclone housing 260, and a seal is formed by an O-ring disposed in an annular groove in the upper surface of flange 340. The flange 460 of the cyclone cartridge 370 also includes an annular groove 490 into which an O-ring seal 500 is placed.

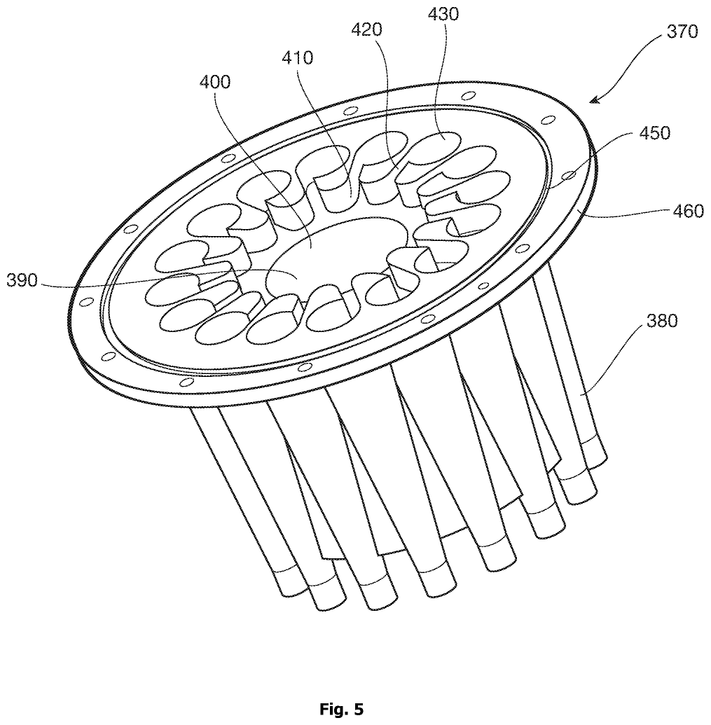

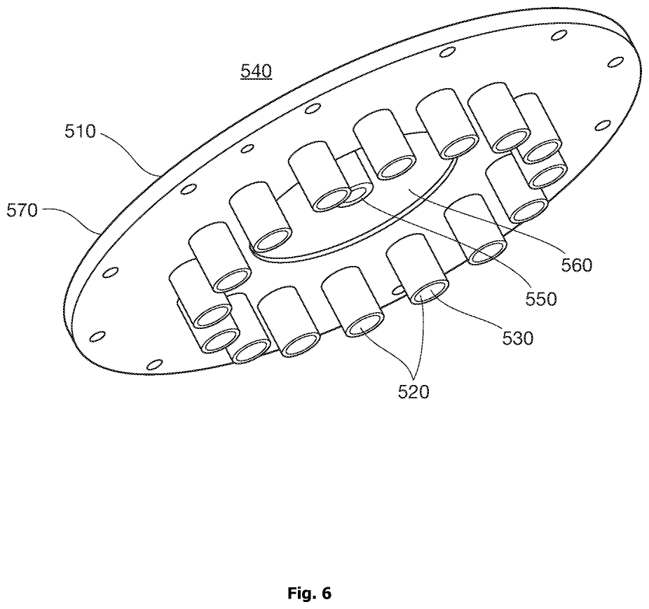

Referring to FIG. 6, the sediment filter and multi-cyclone separator 100 includes a generally planar diffuser plate, or manifold plate, 510, having a plurality of diffuser tubes (vortex tubes) 520 extending downwardly from its underside, each tube is inserted into the upper portion of one the conical cyclones 380, the diffuser tubes having an outer diameter less than that of the upper diameter of the open upper end of the cyclones. Through holes 530 penetrating the diffuser plate bring the diffuser tubes and the cyclones 380 into fluid communication with the space 540 above the diffuser plate. A central hole 550 in the diffuser plate accommodates a diverter cone 560 which directs fluid flowing over it up and away from the diffuser plate 510. When the diffuser plate 510 is placed over the cyclone cartridge 370, it creates a ceiling over the cyclone cartridge 370 and restricts fluid flow paths through the cyclone cartridge, cooperating with the cyclone cartridge 370 structure to create a manifold. The resultant structure limits the available flow path from the cartridge fluid inlet through cyclone cartridge to that of the many vortex openings 410, the vortex channels 420, and the vortex ports 430 to the fluid cyclones 380, where sediment separation takes place during system operation.

The outer (flange) portion 570 of the diffuser plate has a circumference substantially the same as that of the cyclone housing flange 340 and the cyclone cartridge flange 460, such that on assembly, it is seated atop the cyclone cartridge flange. It also includes an annular groove 580 for an O-ring seal 590.

Above the diffuser plate 510 is a dome-shaped cap 600 having an axially disposed neck 610 that extends to a threaded male end 620 adapted for attachment to a fluid outlet pipe 630 through a locking ring 640. As with the elements disposed below the cap 600, the cap 600 includes a flange portion or circumferential ring 650 that is dimensionally substantially identical to the inferior flange portions. Therefore, and as will be appreciated by reference to FIG. 3, the multi-cyclone housing 260, the cyclone cartridge 370, the diffuser plate 510, and the cap 600 are secured to one another by screws 660 that pass through aligned apertures in each of the flange portions of the elements. In the preferred embodiment, the screws 660 have a countersunk style head. However, it will be appreciated that other screws, bolts, or other such fasteners may be deployed.

Additionally, it is the dome shaped cap 600 that creates an open space 540 above the diffuser plate 510 through which fluid flows after leaving the fluid cyclones 380 in the cyclone cartridge 370 and before exiting the filter through the fluid outlet 630.

In the embodiment of FIG. 10, the cap 600 is upwardly tapered around its circumferential perimeter. The angle of the taper is preferably about 21 degree, as shown in FIG. 10, and configured to engage with the band 267 of FIG. 11.

Fluid (typically pool or pond water) is introduced through the fluid inlet tube 130 from a pressurized source, such as a pump. The water then continues up the fluid conduit 300 and then into and through the cyclone cartridge inlet tube 390. As it reaches the flared upper portion 405 of the cyclone cartridge inlet tube, the fluid flows outwardly, where it is further diverted by engagement with the structural elements of the cyclone cartridge 370, which creates restricted flow paths sending the fluid through the vortex inlets 410, vortex channels 420, and vortex ports 430, where the fluid is then directed into the sides of the open upper ends of the cyclones 380 and around the vortex tubes 520 partially extending into the cyclones 380. With this fluid path, fluid under constant pressure and continuous flow induces a fluid vortex in the cyclones 380. The vortex spins heavy sediment particles outwardly through centrifugal force, which then drop downwardly under the influence of gravity to the bottom of the cyclone 380 and through the bottom openings in the cyclones 380. The difference in size between the available outlets in the cyclones creates a pressure differential from top to bottom, and in contrast to heavy particles, the fluid proceeds upwardly through the diffuser plate holes 530 and finally out the fluid outlet 630. The sediment continues to fall and eventually collects in the sump 120 at the bottom portion of the sediment bowl 110.

The multi-cyclone sediment filter 100 reduces backwashing, extends filter cartridge life, obviates the need to clean or replace filter media, and is extremely simple to clean. The multi-cyclone sediment filter 100 requires little or no maintenance, as there are no moving parts to fail or wear out, or filter media to clean or replace. The accumulation of sediment can be visibly monitored through a transparent sediment sump 120. The sediment is simply discharged by opening the purge valve 210. Only a small amount of water is discharged to purge the filter of sediment. Thus, the multi-cyclone is perfectly suited for pre-filtration to extend the filtration cycle of an existing filter.

The multi-cyclone sediment filter 100 provides a way for rapid parts replacement and maintenance, particularly with respect to the cyclone cartridge or magazine 370. This is accomplished by disconnecting the fluid outlet and then removing the bolts 650 securing the filter elements in a stacked sandwich configuration. The cyclone cartridge 370 can simply be lifted out from the cyclone housing 260 and replaced with a new cyclone magazine while the removed cartridge can be cleaned, reconditioned, or simply discarded.

It will be appreciated that the fluid inlet path need not come from directly underneath the sediment bowl 110. In contrast, any of a number of fluid inlet paths could be employed, as long as the fluid is delivered into the cyclone housing and cyclone cartridge in such a way as to ensure distribution into the multiple cyclones 380. Thus, the fluid inlet tube 130 could be disposed through the side of the sediment bowl 110, or even through the side of the cyclone housing 260.

Further, it will be appreciated that alternative attachment means could be employed for securing the structural elements in the stacked configuration described and illustrated. For instance, rather than using a plurality of screws 660 passing through similarly sized flanges, additional threaded locking collars could be employed.

Referring to the tables below, the first table shows the % debris collected in the applicant's original system, the subject of PCT/IB2008/001633. In contrast, the present invention is depicted in the second table. It is noted that at higher flow rates, the % of debris that is removed is considerably improved in the present invention.

DE collection comparison
Bucket + Water = 7 kg
Bucket + Water + DE = 8 kg
Net DE = 1 kg
MC16 Original (20200620)
Test Date: 22 Jun. 2020
Test Report Number:
Pump: Turboflo 200

| | Total | Net DE | Total DE |
|---|---|---|---|
| Flow l/m | Collected kg | Collected kg | Collected % |
| 340 | 7.927 | 0.927 | 92.7 |
| 320 | 7.923 | 0.923 | 92.3 |
| 280 | 7.921 | 0.921 | 92.1 |
| 240 | 7.92 | 0.92 | 92 |
| 200 | 7.919 | 0.919 | 91.9 |
| 160 | 7.915 | 0.915 | 91.5 |
| 120 | 7.901 | 0.901 | 90.1 |
| 80 | 7.831 | 0.831 | 83.1 |
| 40 | 7.707 | 0.707 | 70.7 |

MC16 Integrated 10% B15 V2
Test Date: 11 Nov. 2020
Test Report Number: 20201111-MC-28
Pump: Turboflo 200

| | Total | Net DE | Total DE |
|---|---|---|---|
| Flow l/m | Collected kg | Collected kg | Collected % |
| 340 | 7.999 | 0.999 | 99.9 |
| 320 | 7.998 | 0.998 | 99.8 |
| 280 | 7.991 | 0.991 | 99.1 |
| 240 | 7.99 | 0.99 | 99 |
| 200 | 7.985 | 0.985 | 98.5 |
| 160 | 7.98 | 0.98 | 98 |
| 120 | 7.975 | 0.975 | 97.5 |
| 80 | 7.971 | 0.971 | 97.1 |
| 40 | 7.721 | 0.721 | 72.1 |

The tables above are also graphically represented in the chart below, which highlights the improvements in filtration performance with respect to the amount of collected waster (DE):

In the tables and chart below, the first table shows the pressure drop in the applicant's original system, the subject of PCT/IB2008/001633. In contrast, the pressure drop in the present invention is depicted in the second table. It is noted that at each flow rate, a greater pressure drop is achieved in the present invention.

Pressure Drop Test Comparison
Test Report Number: 20201111-MC-29
MC 16 Original (20201030)
Test Date: 30 Oct. 2020
Test Report Number:
Pump: Turboflo 200

| Flow L/M | Pressure difference Kpa |
|---|---|
| 340 | 49.25 |
| 320 | 46.6 |
| 280 | 38.2 |
| 240 | 29.4 |
| 200 | 20 |
| 160 | 12 |
| 120 | 6.15 |
| 80 | 2.2 |
| 40 | 0.35 |

MC16 Integrated 10% B15 V2 (20201111-MC-28)
Test Date: 11 Nov. 2020
Test Report Number: 20201111-MC-28
Pump: Turboflo 200

| Flow L/M | Pressure difference Kpa |
|---|---|
| 340 | 41.09 |
| 320 | 37.26 |
| 280 | 31.27 |
| 240 | 25.35 |
| 200 | 19.41 |
| 160 | 13.38 |
| 120 | 7.26 |
| 80 | 2.72 |
| 40 | 0.44 |

Although the invention has been described with reference to specific examples, it will be appreciated by those skilled in the art that the invention may be embodied in many other forms.

1. A multi-cyclone sediment filter comprising:
a sediment bowl for collecting sediment;
a cyclone housing disposed above and sealingly connected to said sediment bowl;
a cyclone cartridge disposed in said cyclone housing, said cyclone cartridge including:
a plurality of conically shaped fluid cyclones, each having a small opening at a lower end and larger opening at an upper end,
a fluid inlet for introducing fluid into said cyclone housing and for passage through said cyclone cartridge;
a diffuser plate sealingly connected to said cyclone cartridge and said cyclone housing, said diffuser plate including a plurality of diffuser tubes, each diffuser tube extending downwardly into an upper open portion of one of said fluid cyclones, and a central upwardly extending diverter cone for directing fluid over said diverter cone up and away from said diffuser plate;
wherein the sediment bowl includes a sump which is angularly inclined relative to a plane which is perpendicular to a longitudinal axis of the multi-cyclone sediment filter, and a discharge port is located at or near a lowermost region of said sump.

2. The multi-cyclone sediment filter of claim 1, wherein the cyclone cartridge includes 12 cyclones.

3. The multi-cyclone sediment filter of claim 1, wherein the cyclone cartridge includes 16 cyclones.

4. The multi-cyclone sediment filter of claim 1, wherein each cyclone has a truncated conical body which decreases in cross-section area from an upper region of the cyclone cartridge toward a lower region of the cyclone cartridge, wherein a narrow end of each cyclone terminates at a tubular outlet.

5. The multi-cyclone sediment filter of claim 4, wherein the tubular outlet is about 15 mm in length.

6. The multi-cyclone sediment filter of claim 4, wherein the tubular outlet has an internal diameter of about 8.9 mm.

7. The multi-cyclone sediment filter of claim 1, where centres of the cyclones are located on a pitch circle diameter of about 154 mm.

8. The multi-cyclone sediment filter of claim 5, wherein the tubular outlet has an internal diameter of about 8.9 mm.

9. The multi-cyclone sediment filter of claim 2, wherein each cyclone has a truncated conical body which decreases in cross-section area from an upper region of the cyclone cartridge toward a lower region of the cyclone cartridge, wherein a narrow end of each cyclone terminates at a tubular outlet.

10. The multi-cyclone sediment filter of claim 9, wherein the tubular outlet is about 15 mm in length.

11. The multi-cyclone sediment filter of claim 10, wherein the tubular outlet has an internal diameter of about 8.9 mm.

12. The multi-cyclone sediment filter of claim 3, wherein each cyclone has a truncated conical body which decreases in cross-section area from an upper region of the cyclone cartridge toward a lower region of the cyclone cartridge, wherein a narrow end of each cyclone terminates at a tubular outlet.

13. The multi-cyclone sediment filter of claim 12, wherein the tubular outlet is about 15 mm in length.

14. The multi-cyclone sediment filter of claim 12, wherein the tubular outlet has an internal diameter of about 8.9 mm.

15. The multi-cyclone sediment filter of claim 2, where centres of the cyclones are located on a pitch circle diameter of about 154 mm.

16. The multi-cyclone sediment filter of claim 3, where centres of the cyclones are located on a pitch circle diameter of about 154 mm.

17. The multi-cyclone sediment filter of claim 4, where centres of the cyclones are located on a pitch circle diameter of about 154 mm.

18. The multi-cyclone sediment filter of claim 5, where centres of the cyclones are located on a pitch circle diameter of about 154 mm.

19. The multi-cyclone sediment filter of claim 6, where centres of the cyclones are located on a pitch circle diameter of about 154 mm.
